(19) United States
(12) Patent Application Publication
(10) Pub. No.: US 2009/0288887 A1
(43) Pub. Date: Nov. 26, 2009

(54) Electronic scale

(76) Inventor: Jiunn-rong Chen, Taichung City (TW)

Correspondence Address: CHARLES E. BAXLEY, ESQUIRE, 90 JOHN STREET, SUITE 309, NEW YORK, NY, 10038, US

(21) Appl. No.: 12/154,043

(22) Filed: May 20, 2008

(51) Int. Cl. G01G 19/34

(52) U.S. Cl. 177/25.13

(57) ABSTRACT

An electronic scale serves to weight a food and provide information through a screen. The information comprises a category and a name of the food, and calories as well as nutritional elements contained in the food of such weight.

### BACKGROUND OF THE INVENTION

1. Technical Field

The present invention relates to weighting apparatuses and, more particularly, to an electronic scale primarily serving to weight foods and provide nutritive information of the food being weighted, such as nutritive elements, calories contained therein, and so on.

2. Description of Related Art

Many chronic diseases such as hypertension, diabetes, and gout, have been proven in connection with overweight and exceeding yet unbalanced nutrition intake. While dietary management is a crucial issue for preventing and remedying such chronic diseases, it is also a real challenge to put the same into practice. This is because patients are usually not exactly aware of their personal food taboos or restrictions. Meantime, most patients are ignorant of correct calculating measures for calorie intake and seldom familiar with the ingredients and levels of nutritional elements contained in the foods they ingest. In case that a patient fails to tell the surfeit or lack of the nutritional elements, he/she has noneffective measure to determine whether his/her diet is balanced or not, and is therefore handicapped in properly managing his/her diet by following advices form his/her doctor or dietician.

Currently, the primary method for measuring calories of foods is first weighting a food to be ingested, checking a food calories list and conducting conversion to figure out the calories of the food of the presently measured weight. Such a calculating process is inconvenient and tends to generate errors of computation so is difficult for people to persevere at, rendering their dietary management obstructed. Besides, while people conventionally pay attention to food calories only and ignore balanced nutrition intake, the dietary management is just partially conducted and the objectives and effects of dietary management cannot be truly achieved.

### SUMMARY OF THE INVENTION

One objective of the present invention is to provide an electronic scale, which helps a user to easily conduct dietary management in his/her daily life, so as to improve efficiency of the user's health management.

Another objective of the present invention is to provide an electronic scale, which serves to display nutritive information such as weight, calories, nutritional elements, contents of the nutritional elements of a food weighted thereon.

Another objective of the present invention is to provide an electronic scale, which serves to automatically calculate calories and contents of the nutritional elements of a food weighted thereon according to the measured weight of the food, so that a user can be informed of nutritive information about the food without additional conversion.

Another objective of the present invention is to provide an electronic scale, where a users' name, age, height, weight, recommended daily calories, and recommended intake amount of or intake restriction on certain nutritional elements can be input and stored before use, so that when the electronic scale weights a food, the aforementioned information is taken for comparison, conversion and analyses and the results are presented for the users reference. Consequently, the user may increase or decrease his/her intake of the food according to the results. The electronic scale may further give a warning message when the food weighted thereon contains calories or nutritional elements exceeding the recommended intake amount so as to advise the user to reduce or cease his/her ingestion of the food.

Another objective of the present invention is to provide an electronic scale, wherein a general food database is built therein for storing comprehensive and manifold food information, such as categories, names, calories, nutritional elements, contents of nutritional elements, beneficial effects and so on. The foregoing food comprises raw foods, such as raw fish, raw pork, vegetables, rice, flour and so on. The general food database is updatable.

Another objective of the present invention is to provide an electronic scale, wherein a personal food database is built for storing categories, names, calories, nutritional elements, and contents of nutritional elements of foods frequently ingested by at least one user. The foods frequently ingested comprises cooked composite foods, such as corn soup, boiled dumplings, fried vegetables, deep fried fish, pizza and so on. The personal food database is updatable.

Still another objective of the present invention is to provide an electronic scale, where a user's dietary information can be stored in a dietary record database for later inquiry. The dietary information comprises names, calories, and contents nutritional elements of cooked foods.

Yet another objective of the present invention is to provide an electronic scale, which can be connected to a medical service platform at a hospital or a health service center so that medical staff in the hospital or the health service center can collect and recognize status of a medical-care-recipient's dietary management.

To achieve these and other objectives of the present invention, an electronic scale is proposed for weighting a food, and presenting information of the food, such as names, calories, contents of nutritional elements, and beneficial effects, in a screen of the electronic scale. The electronic scale can be further connected to an external system through a connecting device, wherein the connecting device is built in the electronic scale and connected to a microprocessor of the electronic scale so that the microprocessor can come into communication with the external system and the external system comprises a food database system, a user ID database system or a medical service platform.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a schematic drawing showing an electronic scale according to the present invention;

FIG. 2 is another schematic drawing showing the electronic scale according to the present invention; and

FIG. 3 is yet another schematic drawing showing the electronic scale according to the present invention.

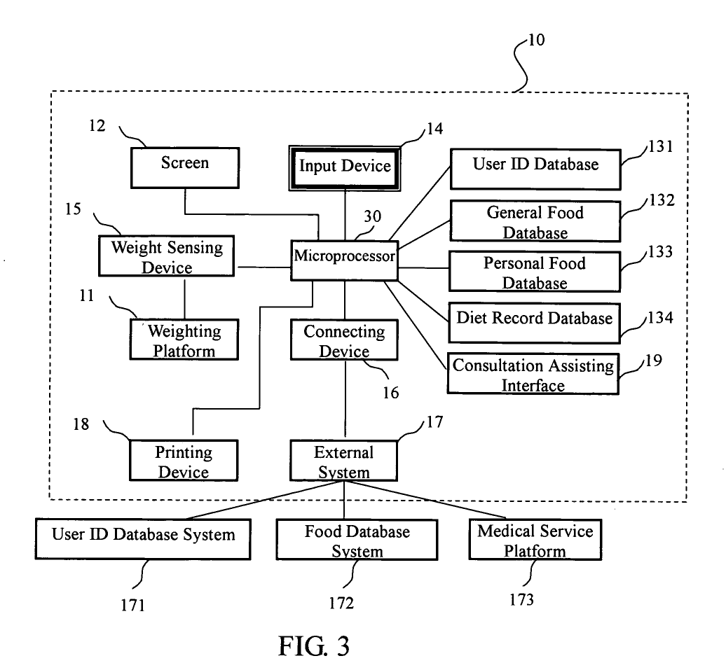

### DETAILED DESCRIPTION OF THE PREFERRED EMBODIMENT

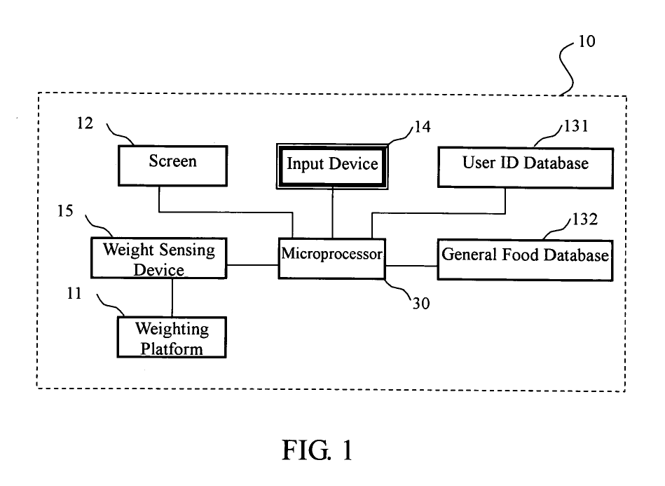

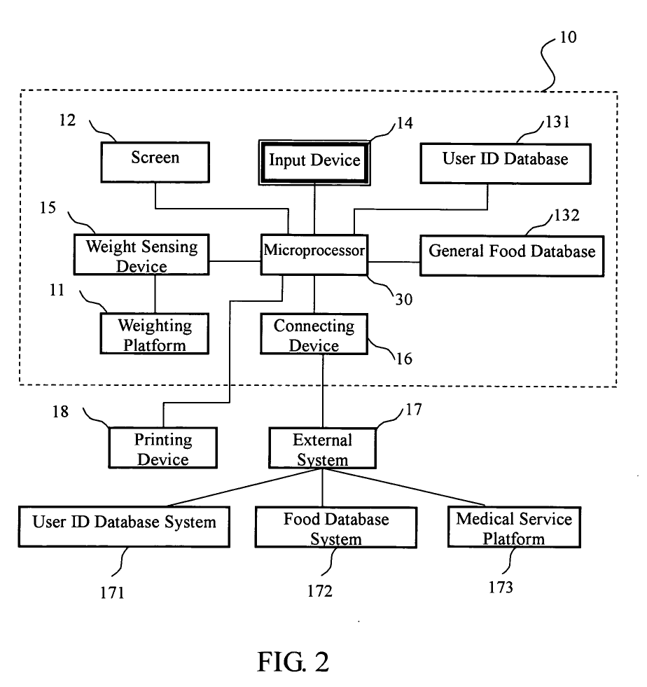

Referring to FIGS. 1 and 2, an electronic scale 10 of the present invention primarily comprises a microprocessor 30, an input device 14, a user ID database 131, a general food database 132, a weighting platform 11, a personal food database 133, a dietary record database 134, a connecting device 16, a printing device 18, and a assistant consultation interface 19, which will be described in detail below.

The microprocessor 30 is built in the electronic scale 10 for inputting, outputting, storing, analyzing, and computing data with respect to the electronic scale 10. The microprocessor 30 has an internal program and the internal program presents an operational interface at a screen 12 that is provided at an exterior of the electronic scale 10 at a position easy to be viewed by a user.

The input device 14 and the user ID database 131 are connected to the microprocessor 30. The input device 14 may be a plurality of keys built at the exterior of the electronic scale 10 to be pressed by a user, a touch screen or an external keyboard so that a user can use the input device 14 in conjunction with the operational interface to input commands or input the user's personal information and store the same into the user ID database 131. The users' personal information may include name, age, height, weight, diseases, special physiological status (such as pregnancy), recommended daily calories, recommended intake amount of or intake restriction on certain nutritional elements, and so on. Data in the user ID database 131 can be updated, revised, deleted and printed out. Besides, the user ID database 131 can receive inquiry and conduct search.

The general food database 132 is built in the electronic scale 10 and connected to the microprocessor 30 for storing comprehensive and various food information, such as categories, names, calories, nutritional elements, contents of nutritional elements, beneficial effects and so on. The foregoing food comprises raw foods, such as raw fish, raw pork, vegetables, rice, flour and so on. The information is presented in the screen 12 in the form of an expression tree for the user to read and select through the input device 14. The general food database 132 can be upgraded and revised while the data therein can be deleted and printed out. Also, the general food database 132 can receive inquiry and conduct search.

The weighting platform 11 is settled at a top surface of the electronic scale 10 for receiving the food to be weighted. A weight sensing device 15 provided inside the electronic scale 10 is connected to the weighting platform 11 and the microprocessor 30 for weighting the food so that the weight of the food can be compared with the data in the general food database 132 for further analyses and computed in order to present the food category, name and calories as well as contents of nutritional elements contained in the food of the weight at the screen 12 for the user's reading. Consequently, the user is fully informed of nutritive information of the food of the weight and may increase or decrease his/her ingestion of the food accordingly.

The personal food database 133 is built in the electronic scale 10 and connected to the microprocessor 30 for storing names, calories, nutritional elements, and contents of nutritional elements of foods frequently ingested by at least one user. The foods frequently ingested comprises cooked composite foods, such as corn soup, boiled dumplings, fried vegetables, deep fried fish, pizza and so on. The personal food database 133 can be upgraded and revised while the data therein can be deleted and printed out. Also, the personal food database 133 can receive inquiry and conduct search.

The dietary record database 134 is built in the electronic scale 10 and connected to the microprocessor 30 for storing dietary information in a past time period of at least one user for later inquiry. The dietary information comprises names, calories, and contents of nutritional elements of cooked foods. The dietary record database 134 can be upgraded and revised while the data therein can be deleted and printed out. Also, the dietary record database 134 can receive inquiry and conduct search.

The connecting device 16 is built in the electronic scale 10 and connected to the microprocessor 30 for communicating with an external system 17. The external system 17 may include a user ID database system 171, a food database system 172 and a medical service plate 173. The connecting device 16 connects the external user ID database system 171 to the electronic scale 10 so as to update the user ID database 131. The connecting device 16 connects the external food database system 172 to the electronic scale 10 so as to update the general food database 132. The connecting device 16 connects the electronic scale 10 to the medical service plate 173 at a hospital at a health management center so as to transmit the dietary information in the dietary record database 134 to the medical service plate 173 and fully inform medical staff partaking treatment of the diet conditions of the medical-care-recipient.

The printing device 18 may be built in or settled outside the electronic scale 10 for printing the data processed by the electronic scale 10.

The assistant consultation interface 19 is contained in the built-in program of the microprocessor 30 and presented in the screen 12 so that names and weights of foods, names and amounts of a seasonings, oil amounts, and cooking methods for cooking foods can be inputted by using the input device 14, and transmitted to the medical service platform 173 through the connecting device 16. The above information may be then used to calculate the calories and contents of nutritional elements of the cooked foods and returned to the electronic scale 10 for being presented in the assistant consultation interface 19. The user can store all the data presented in the assistant consultation interface 19 into the personal food database 133 for later inquiry. In addition to using the assistant consultation interface 19, the user can also photo the cooked food into photographs and transmit the photographs to the medical service platform 173 through a computer, a mobile communicating device so as to obtain information of the cooked food, such as calories and nutritional elements.

When the electronic scale 10 of the present invention weights a food, the user can use the operational interface presented in the screen 12 to select food category and name corresponding to the food. After the weight sensing device 15 detects the weight of the food, the microprocessor 30 can search the food category and name in the general food database 132 so as to calculate the calories and contents of nutritional elements of the food according to the weight of the food and present the calculated calories and contents of nutritional elements in the screen 12 for the user to read. Namely, the user is allowed to fully learn the calories and contents of nutritional elements of the food at the time of weighting it. The microprocessor 30 can also briefly present the beneficial effects of the weighted food recorded in the general food database 132 at the screen 12 for the user's reference. By using the disclosed electronic scale 10, the user can be free from the trouble of checking the food calories list and calculating the calories of foods by himself/herself, thereby simplifying the practice of dietary management and making the same easy to be exactly performed in the user's daily life so as to improve the effect of dietary management. What is more important, by using the disclosed electronic scale 10, the user can be informed of nutritive information of the food he/she is going to eat, such as calories, contents of nutritional elements and beneficial effects so as to facilitate dietary management.

Besides, the microprocessor 30 can further compare the calculated food calories and contents of nutritional elements with the recommended daily calories and recommended intake amount of or intake restriction on certain nutritional elements stored in the user ID database 131 and provide a warning message in the screen 12 when the values of the former surpasses the defaults set in the latter so as to advise the user to reduce or cease his/her ingestion of the food. Consequently, the risk of relapse subject to the user's improper food ingestion can be eliminated or reduced.

The built-in program in the electronic scale 10 may record and sum up the food categories, names, weights, nutritional ingredients ingested by the user in a day and then compares the same with the recommended daily calories, recommended intake amount of or intake restriction on certain nutritional elements stored in the user ID database 131 so as to present the comparison in the screen 12 for the user to recognize his/her nutrition intake status.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. An electronic scale, comprising:
a microprocessor, settled in the electronic scale for inputting, outputting, storing, analyzing, and computing data by using a built-in program;
a screen, provided at a surface of the electronic scale for being easily viewed by a user and for displaying an operational interface of the built-in program;
a general food database, which is built in the electronic scale and connected to the microprocessor for storing comprehensive and manifold food information, such as categories, names, calories, nutritional elements, contents of the nutritional elements, beneficial effects and so on;
a weighting platform, settled on a top surface of the electronic scale, for receiving a food to be weighted; and
a weight sensing device, which is built in the electronic scale and connected to the weighting platform and the microprocessor, wherein the weight sensing device weights a weight of the food and the microprocessor identifies the food with the corresponding food information in the general food database so as to present calories, contents nutritional elements of the food of the weight in the screen.

2. The electronic scale as claimed in claim 1, further comprising a user ID database that is connected to the microprocessor and stores a personal information of at lease one user of the electronic scale.

3. The electronic scale as claimed in claim 2, further comprising an input device that is connected to the microprocessor.

4. The electronic scale as claimed in claim 3, wherein the input device comprises a plurality of keys built at an exterior of the electronic scale to be pressed by the user.

5. The electronic scale as claimed in claim 3, wherein the input device is a touch screen.

6. The electronic scale as claimed in claim 3, wherein the input device is an external keyboard.

7. The electronic scale as claimed in claim 1, further comprising a connecting device that is built in the electronic scale and connected to the microprocessor for communicating with an external system.

8. The electronic scale as claimed in claim 7, wherein the external system is a food database system.

9. The electronic scale as claimed in claim 7, wherein the external system is a user ID database system.

10. The electronic scale as claimed in claim 7, wherein the external system is a medical service platform.

11. The electronic scale as claimed in claim 1, further comprising a printing device that is connected to the microprocessor.

12. The electronic scale as claimed in claim 11, wherein the printing device is built in the electronic scale.

13. The electronic scale as claimed in claim 11, wherein the printing device is settled outside the electronic scale.

14. The electronic scale as claimed in claim 1, further comprising a personal food database that is built in the electronic scale and connected to the microprocessor for storing names, calories, nutritional elements, and contents of the nutritional elements of foods frequently ingested by at least one said user.

15. The electronic scale as claimed in claim 14, further comprising a dietary record database that is built in the electronic scale and connected to the microprocessor for storing dietary information in a past time period of at least one said user.

16. The electronic scale as claimed in claim 1, further comprising a assistant consultation interface that is contained in the built-in program of the microprocessor and presented in the screen.
